(19) United States
(12) Patent Application Publication
(10) Pub. No.: US 2002/0116088 A1
(43) Pub. Date: Aug. 22, 2002

(54) System for dispensing a consumer product

(75) Inventor: Steven Howard Rowe, London (GB)

Correspondence Address: Jules E. Goldberg Esq., Reed Smith LLP, 375 Park Avenue, New York, NY, 10152, US

(73) Assignee: AIRCRAFTS LIMITED

(21) Appl. No.: 09/788,879

(22) Filed: Feb. 20, 2001

(51) Int. Cl. G07F 11/00; B65H 1/00; B65G 59/00; G06F 17/60; G06F 17/00

(52) U.S. Cl. 700/237; 700/233; 700/238; 705/14; 221/1

(57) ABSTRACT

A system for dispensing and containing a consumer product to a customer comprising the receiving a purchaserequest for the consumer product; presenting at least one question to the customer wherein the customer is asked if the customer will pay an extra fee to receive the consumer product in a toy container machine shaped like a model airplane with a moveable cargo door for accessing the consumer product; receiving an answer to the question from the customer, and; dispensing the consumer product in the toy container machine shaped like a model airplane with a moveable cargo door for accessing the consumer product if the answer indicates that said consumer agrees to pay the extra fee. Alternatively, no fee may be charged and a logo for or a business may be included on the toy container machine shaped like a model airplane. The system is particularly useful in airports.

### FIELD OF INVENTION

The present Invention relates to the field of dispensing consumer products in containers, and to dispensing consumer products using vending machines.

### BACKGROUND OF INVENTION

Sellers of goods of goods have always recognized that a consumer who is already committed to making a purchase is about forty percent likely to include an ancillary purchase with the main purchase, if the consumer is appropriately solicited. For example, a small discount on the ancillary good is included in light of the fact that the consumer is already buying the main good. It also well known that unique packaging that is reusable such as flowers in a vase may significantly contribute to making a sale. Further, inexpensive novelty items which are typically bought on impulse by a buyer who considers the expense nominal have an even higher rate of sale if the packaging is especially attractive to the impulse buying of the consumer.

In settings such as airports where consumer are effectively confined for relatively long periods of time, a seller of goods has an especially fertile environment for sales.

Methods for supplying products in specific containers are known, for example U.S. Pat. No. 5,794,645 for supplying industrial gases using integrated bottle controllers.

Also, patents such as U.S. Pat. No. 6,161,059 for a vending machine method and apparatus for encouraging participation in a marketing effort have issued for methods and systems combining dispensing consumer goods with asking the consumer questions for marketing survey use and providing the consumer a reward for answering the marketing survey.

However, there is a need for a new system of dispensing consumer products in containers and in particular for aviation theme containers in airports due to increased competition and deregulation in the airline industry which has led to an unprecedented number of mergers wherein the brand names associated with airlines and other aviation industries are extremely valuable in the portfolio valuation of said companies including valuing business good will for accounting purposes.

### OBJECTS AND SUMMARY OF THE INVENTION

Therefore, the present invention provides as useful machine which is used to dispense and contain a variety of consumer goods, and which is particularly well suited for use in airports wherein consumers are both more aware of aviation in general than they are ordinarily, and wherein they are also more likely than usual to make an impulse purchase of a novelty item or product for entertainment in flight.

Therefore, a first object of the present invention is a method for dispensing a consumer product to a customer, said method comprising the steps of receiving a purchase request for said consumer product; presenting at least one question to said customer wherein the customer, is asked if said customer will pay an extra fee to receive said consumer product in a toy container machine shaped like a model airplane with a moveable cargo door for accessing said product; receiving an answer to said question from said customer, and; dispensing said consumer product in said toy container machine shaped like a model airplane with a moveable cargo door for accessing said product if said answer indicates that said consumer agrees to pay said extra fee.

A second object of the invention includes the further combination step of displaying logos of a particular brand for promoting said particular brand on said toy container machine shaped like a model airplane with a moveable cargo door for accessing said consumer product.

A third object of the invention includes the further combination step of displaying logos promoting said consumer product on said toy container machine shaped like a model airplane with a moveable cargo door for accessing said consumer product.

A fourth object of the invention is to provide a machine for containing a consumer good and for displaying a product logo comprising: a toy container machine scaled and shaped like a model airplane having a hollow fuselage; said fuselage accessible for storage of a consumer product via a moveable cargo door connected to said fuselage; said toy container machine scaled and shaped like a model airplane, provided with brand logo display means, said means comprising the steps of: receiving a purchase request for said consumer product; presenting at least one question to a customer wherein said customer is askedif said customer will accept said consumer product in said toy container machine scaled and shaped like a model airplane, and; providing said toy container machine scaled and shaped like a model airplane to said customer with a brand logo for a particular business provider displayed on said toy container machine scaled and shaped like a model airplane.

A fifth object of the invention is to provide a method of supplying a consumer good in a container machine comprising the steps of: providing a container machineshaped like an airplane; said container machine shaped like an airplane including a moveable cargo door for accessing a hollow chamber within said container machine shaped like an airplane, and; placing said consumer good in said container machine shaped like an airplane through said moveable cargo door.

The consumer good is a typically, but not limited to, a puzzle, a toy, a game, a food, a vacuum compressed T-shirt or clothing, a novelty item, an article of arts and crafts, a book, or a magazine.

A sixth object of the invention is to provide avending machine system for dispensing a consumer product, said vending machine comprising: a purchase request processing device for receiving a purchase request for said consumer product; an output device for presenting at least one question to said customer in response to said purchase request, said at least one question including asking the customer if it agrees to accept said consumer product dispensed in a toy container machine shaped like a model airplane with a moveable cargo door for accepting and dispensing said consumer product; a dispensing device for dispensing said consumer product to said customer, wherein said consumer product is either enclosed in said toy container machine shaped like a model airplane with a moveable cargo door for accepting and dispensing said consumer product or is dispensed in a normal product enclosure depending upon an answer to said at least one question from said customer. The system may require said customer to pay an extra fee to have said product dispensed in said toy container machine shaped like a model airplane with a moveable cargo door for accessing said product.

The purchase request processing device may information said customer that said product may be elected by said customer to be dispensed for no additional charge in said toy container machine shaped like a model airplane with a moveable cargo door for accessing said product if the consumer agrees to accept said consumer product in said toy container machine shaped like a model airplane with a moveable cargo door with at least one marketing logo for at least one business affixed thereto.

A seventh object of the invention may be to provide in the system a container machine comprising: a toy container machine shaped like a model airplane having a hollow fuselage; said fuselage accessible for storage of a consumer product via a moveable cargo door connected to said fuselage, and;said toy model airplane container may be provided with a brand name.

An eighth object of the invention is provide all of the above objects at an airport.

### BRIEF DESCRIPTION OF THE DRAWINGS

Fig. 1 is diagram of a vending machine system according to the present invention.

FIG. 2 is a flow diagram of the basic logic of the system of the present invention.

FIG. 3 is a side view of the container machine shaped like a model airplane with a moveable cargo door for accessing a consumer product of the present invention.

FIG. 4 is a side view similar to that of FIG. 3 of the container machine with the cargo in closed position.

### DETAILED DESCRIPTION

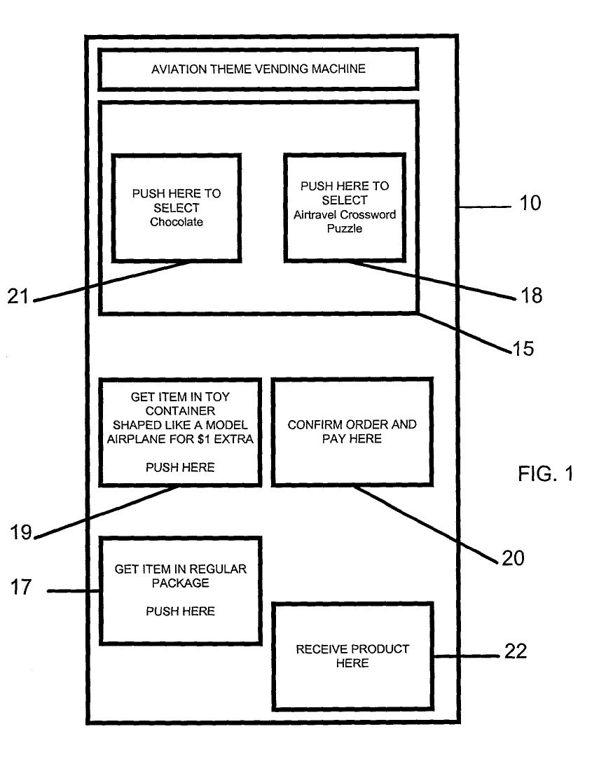

In general, upon review of FIGS. 1, 2, and 3 the system of the present invention is shown.

Vending machines are established as useful sales tools. However, there is a constant effort in the industry to improve the level of sales which occur atvending machines. Also, there is increased need to increase brand awareness in aviation and other competitive industries.

In FIG. 1, a vending machine 10 is shown in accordance with the system of the present invention shown in FIGS. 1-3.

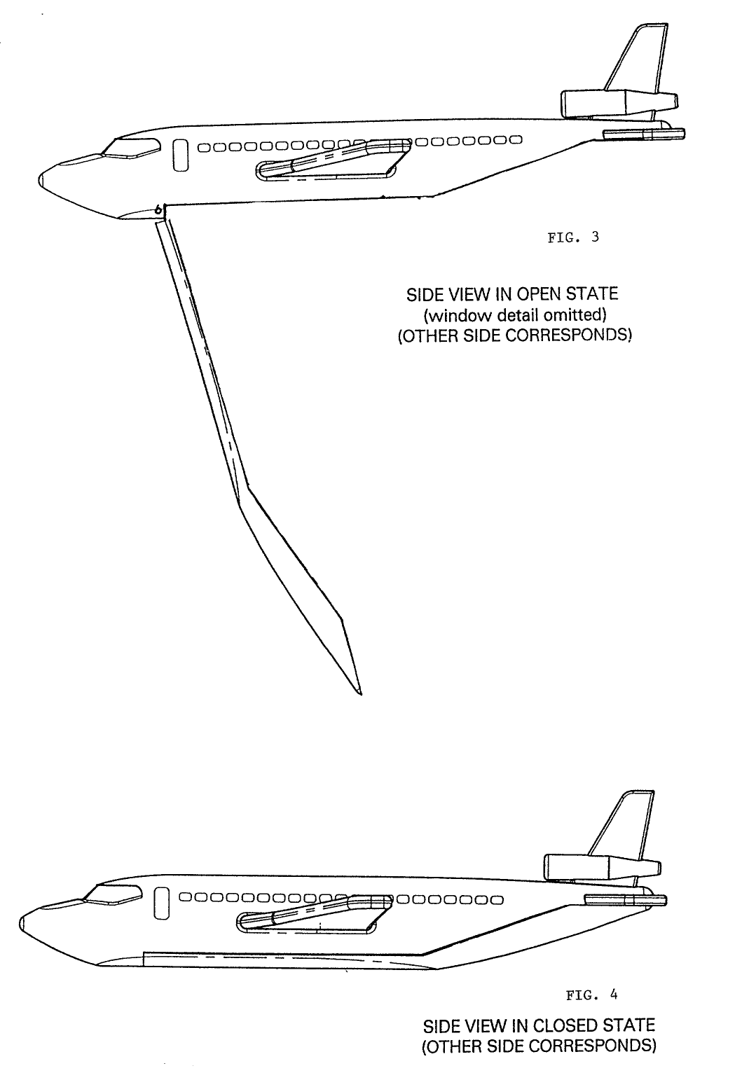

FIGS. 3-4 show the container machine shaped like a model airplane 40 of the present invention with a moveable cargo door 45 connected thereto at a pivot point 47. Although this is the preferred embodiment structure, other standard access door structures are envisioned to be within the scope of the present invention. A consumer product 60 is enclosed within the container machine shaped like a Model airplane 40 of the present invention for sale to a customer. A brand logo So maybe included on the container machine shaped like a model airplane 40 of the present invention.

In the preferred embodiment as shown in FIG. 1, the customer selects a consumer good 60 from a typical selection of consumer goods offered at a vending machine. For example, the consumer good 60 may be, but is not limited to, a puzzle, a game, a food, a vacuum packed T-shirt, a novelty item, a magazine, an article of arts and crafts, or book. All of these items are typically purchased in an airport for in flight supplemental entertainment by consumers including air travelers.

The vending machine 40 contains the usual means for viewing and selecting the consumer product 60 including display windows (not shown) and push buttons 21 and 18. Any number of push buttons or goods, as practical, can be provided. The push buttons may be electronic or mechanical in operation. Data from the push buttons may be sent to an electronic processor (not shown) for transformation via a standard marketing algorithm (not shown) into reference table of data (not shown) for future use in marketing or in stocking the goods sold in the system. The system may also be provided with a landline or wireless data transceiver (not shown) with a processor for communicating with a central station (not shown). A typical operation of the preferred embodiment is described below.

The customer selects a consumer good to be purchased by selecting the push button for the desired consumer good, i.e., push button 18 to select an air travel crossword puzzle. Next, the customer pushes either push button 19 to receive the consumer good 60 in the container machine shaped like a model airplane 40 of the present invention by paying an extra fee or the customer selects at pushbutton 17 to receive the consumer good 60 in a regular package(not shown) for consumer good 60. Next, the customer confirms the order and pays at pay station 20 which may be any standard bill, coin, or credit card acceptor with a keypad or pushbuttons (not shown).

Alternatively, another embodiment of the invention does not require the customer to pay a fee to receive the consumer good 60 in container machine shaped like a model airplane 40 of the present invention. Rather, the customer is asked if they would accept the consumer good 60 in the container machine shaped like a model airplane 40 of the present invention. Alternatively, the consumer good 40 may also be simply automatically provided to the customer for no additional charge. Either way, the container machine shaped like a model airplane 40 of the present invention may include a brand logo 50. According to the system of the present invention the brand logo corresponds to a brand for a company which may pay for a fee to cover the supply costs of providing the container machine shaped like a model airplane 40 of the present invention as a marketing expense to promote brand identification and business goodwill.

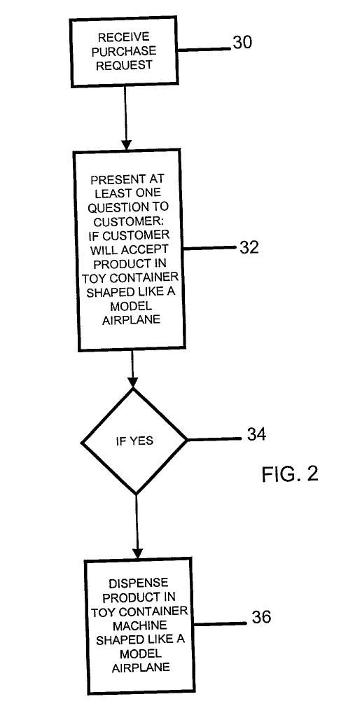

FIG. 2 shows the basic flow of the logic of the system of the present invention described above. First, a purchase request 30 is received. Second, the customer is a asked a question from the point of sale terminal which is a vending machine 10 in the preferred embodiment as shown in FIG. 1. Third, a “yes” answer is received and processed (and the consumer product 60 is paid for(not shown)). Fourth, The consumer product is dispensed in toy container machine shaped like a model airplane with a moveable cargo door for accessing said consumer product at location 22 for example.

One skilled in the art will realize that variations on this disclosure are possible and envisioned by the inventors.

What is claimed is:

1. A method for dispensing a consumer product to
a customer, said method comprising the steps of: receiving a purchase request for said consumer product;
presenting at least one question to said customer wherein said customer is asked if said customer will pay an extra fee to receive said consumer product in a toy container machine shaped like a model airplane with a moveable cargo door for accessing said consumer product;
receiving an answer to said question from said customer, and;
dispensing said consumer product in said toy container machine shaped like a model airplane with a moveable cargo door for accessing said product if said answer indicates that said consumer agrees to pay said extra fee.

2. The method of claim 1 including the further combination step of displaying at least one logo of a particular brand for promoting said particular brand on said toy container machine shaped like a model airplane with a moveable cargo door for accessing said consumer product.

3. The method of claim 1 including the further combination step of displaying at least one logo promoting said consumer product on said toy container machine shaped like a model airplane with a moveable cargo door for accessing said consumer product.

4. The method of claim 1 wherein the method is performed in an airport.

5. A machine for containing a consumer product and for displaying a product logo comprising: a toy container machine scaled and shaped like a model airplane having a hollow fuselage;
said fuselage being accessible for storage of a consumer product via a moveable cargo door connected to said fuselage;
said toy container machine being scaled and shaped like a model airplane, provided with brand logo display means , and the subject of a method comprising the steps of:
receiving a purchase request for said consumer product;
presenting at least one question to the customer wherein said customer is asked if said customer will accept said consumer product in said toy container machine scaled and shaped like a model airplane, and;
providing said toy container machine scaled and shaped like a model airplane to said customer with a brand logo for a particular business provider displayed on said toy container machine scaled and shaped like a model airplane.

6. A method of supplying a consumer good in a container machine comprising the steps of:
providing a container machine shaped like an airplane;
said container machine shaped like an airplane including a moveable cargo door for accessing a hollow chamber within said container machine shaped like an airplane, and;
placing said consumer good in said container machine shaped like an airplane through said moveable cargo door.

7. The method of claim 6 wherein said consumer good is a puzzle.

8. The method of claim 6 wherein said consumer good is a toy.

9. The method of claim 6 wherein said consumer good is a vacuum packed piece of clothing.

10. The method of claim 6 wherein said consumer good is a food.

11. The method of claim 6 wherein said consumer good is a novelty item.

12. The method of claim 6, wherein said consumer good is a book.

13. The method of claim 6, wherein said consumer good is magazine.

14. The method of claim 6 wherein the method is performed in an airport.

15. A vending machine system for dispensing a consumer product, said vending machine system comprising:
a purchase request processing device for receiving a purchase request for said consumer product;
an output device for presenting at least one question to said customer in response to said purchase request, said at least one question including asking the customer if the customer agrees to accept said consumer product dispensed in a toy container machine shaped like a model airplane with a moveable cargo door for accepting and dispensing said consumer product
a dispensing device for dispensing said consumer product to said customer, wherein said consumer product is either enclosed in said toy container machine shaped like a model airplane with a moveable cargo door for accepting and dispensing said consumer product or is dispensed in a normal product enclosure depending upon an answer to said at leastone question from said customer.

16. The vending machine system of claim 15, wherein said purchase request processing device requires said customer to pay an extra fee to have said product dispensed in said toy container machine shaped like a model airplane with a moveable cargo door for accessing said product.

17. The vending machine system of claim 15, wherein said purchase request processing device informs said customer that said product may be elected by said customer to be dispensed for no additional charge in said toy container machine shaped like a model airplane with a moveable cargo door for accessing said productif the consumer agrees to accept said consumer product in said toy container machine shaped like a model airplane with a moveable cargo door with at least one marketing logo for at least one business affixed thereto.

18. A container machine system comprising:
a combination toy and container machine for containing a consumer product, said container machine being shaped like a model airplane and having a hollow fuselage;
said hollow fuselage being accessible for storage of said consumer product via a moveable cargo door connected to said fuselage.

19. The container machine system of claim 18 wherein said combination toy and container machine is provided with a brand name.

20. The container machine system of claim 18 wherein the container machine system is located in an airport.

21. The method of claim 1 wherein the method is performed on board an aircraft.

22. The method of claim 1 wherein the method is performed via a global computer network (Internet).

23. The method of claim 6 wherein the method is performed on board an aircraft.

24. The method of claim 6 wherein the method is performed via a global computer network (Internet).
